(19) United States
(12) Patent Application Publication
(10) Pub. No.: US 2018/0372119 A1
(43) Pub. Date: Dec. 27, 2018

(54) METHOD FOR GENERATING AND SELECTING A MISTUNING PATTERN OF A BLADED WHEEL OF A TURBOMACHINE

(71) Applicant: ROLLS-ROYCE DEUTSCHLAND LTD & CO KG, Blankenfelde-Mahlow (DE)

(72) Inventors: Felix FIGASCHEWSKY, Berlin (DE); Jens NIPKAU, Potsdam (DE); Thomas KLAUKE, Luebbenau/Spreewald OT Gross-Beuchow (DE); Arnold KUEHHORN, Berlin (DE); Bernd BEIROW, Cottbus (DE)

(21) Appl. No.: 16/015,667

(22) Filed: Jun. 22, 2018

(30) Foreign Application Priority Data
Jun. 23, 2017 (DE) 10 2017 113 998.2

(51) Int. Cl. F04D 29/66; F01D 5/10; F01D 5/34; G06F 17/50

(52) U.S. Cl. CPC F04D 29/666; F01D 5/10; F01D 5/34; G06F 2217/16; F05D 2260/961; F05D 2260/81; F05D 2220/32; G06F 17/50

(57) ABSTRACT

A method for selecting a mistuning pattern of a turbomachine rotor disk includes providing information items relative to boundary conditions of a rotor disk excitation by forced vibrations; providing a reduced-order model of the rotor disk; producing a multiplicity of mistuning patterns of the rotor disk by entering the information items and the reduced-order model into a multi-objective optimizer and producing the mistuning patterns by the multi-objective optimizer while optimizing stability of the system in relation to self-excited vibrations while simultaneously optimizing stability of the system relative to forced vibrations. For each mistuning pattern produced, the reduced-order model is applied to a rotor disk, which implements the produced mistuning pattern, and the properties of this rotor disk are determined in view of self-excited vibrations and in view of forced vibrations. One of the mistuning patterns is selected for implementation.

### REFERENCE TO RELATED APPLICATION

This application claims priority to German Patent Application No. 10 2017 113 998.2 filed on Jun. 23, 2017, the entirety of which is incorporated by reference herein.

### BACKGROUND

The invention relates to a method for producing and selecting a mistuning pattern of a rotor disk of a turbomachine having a plurality of rotor blades.

Rotor disks of turbomachines are inevitably manufactured with disturbances in the rotational symmetry caused by the manufacturing process. As a result of these disturbances, the individual blades of a rotor disk are not completely identical to one another but instead have slight geometry and/or material differences from one another. This leads to a deviation in the blade natural frequencies of the individual blades and hence, overall, to a mistuning of the overall structure.

Such a mistuning has an influence on the vibration response of the rotor disk. In the context of the present invention, so-called flutter is considered on one hand. This involves vibrations excited by the blades themselves. On the other hand, the rotor blades can be made to vibrate by forced vibrations that are referred to as a “forced response”. The reason for such forced vibrations lies in asymmetries of the incident air, which are caused by, for example, wake depressions of preceding compressor stages, by the interaction with the potential field of the downstream geometry e.g. fan outlet guide vanes or, in the case of a fan, by an asymmetric incident flow in the engine inlet.

It was discovered that the susceptibility of the blades of a rotor disk to being excited by self-excited vibrations can be reduced by virtue of actively mistuning the rotor disk, so-called intentional mistuning; i.e., targeted deviations of the blade natural frequencies are added to the rotor blades in addition to the deviations of the blade natural frequencies that are down to the manufacturing process and/or material inhomogeneities and consequently random. The intentional mistuning of the system prevents, or reduces, vibratory energy at the resonance frequency of a blade being transported to other blades. A multiplicity of measures are known for realizing such intentional mistuning, said measures varying the blades of a rotor disk geometrically or in terms of their arrangement. By way of example, U.S. Pat. No. 6,428,278 B1 describes the mistuning of a rotor disk by way of material omissions at the blade tip or at the leading edge of the individual rotor blades.

However, improved properties of a rotor disk in view of self-excited vibrations that are achieved by mistuning the system do not necessarily improve the properties of the rotor disk in view of forced vibrations. Indeed, mistuning the rotor disk, increases the susceptibility to forced vibrations in general.

EP 2 762 678 A1 discloses a method for mistuning a rotor blade cascade, in which discrete mass values and radial center-of-mass positions of the rotor blades are recorded together with the respective natural frequency in a value table and an actual natural frequency is determined by interpolation.

The present invention is based on the object of specifying a method that facilitates defining mistuning patterns of a rotor disk that bring about an improvement of the system properties in the case of self-excited vibrations without, in the process, bringing about a substantial deterioration of the system properties in the case of forced vibrations but instead even improving said system properties in this case, too.

### SUMMARY

According to an aspect of the invention, a method for producing and selecting a mistuning pattern for a rotor disk of a turbomachine having a plurality of rotor blades is provided. Here, a mistuning pattern is understood to be a pattern that, in view of at least one vibration mode, specifies a mistuning or a frequency deviation of the natural frequency from a nominal frequency for each rotor blade of the rotor disk. Here, the nominal frequency is the natural frequency that the rotor blades would have in the absence of any mistuning in the vibration mode considered.

Consequently, aspects of the invention relate to the provision of a mistuning pattern that, in view of at least one vibration mode, specifies natural frequencies of the rotor blades, wherein the natural frequencies of the individual rotor blades differ from one another and, as a result thereof, provide the mistuning of the rotor disk overall.

By contrast, the practical realization of the respective rotor blades to the effect of realizing the natural frequencies of the selected mistuning pattern is not part of the subject matter of the invention. This can be carried out in a manner known per se, for example by way of geometric changes on the individual rotor blades.

Aspects of the invention implement a multi-objective optimization, which is carried out on the basis of defined input information items and a simplified model for describing the rotor blade and determining the blade frequencies.

Thus, first information items are provided for the multi-objective optimization, said first information items relating to the boundary conditions of a rotor disk excitation by forced vibrations. These boundary conditions specify asymmetries of the incident air, which leads to the separate excitation of the rotor blades. To this end, the first information items provide, for example, information items in relation to wake depressions of compressor stages arranged upstream, information items about the wind shadow of structures arranged upstream and/or information items in relation to the distribution of the flow in the engine inlet under defined conditions, for example in the case of crosswind.

Further, the method uses a reduced-order model (ROM) for describing the rotor disk or for calculating the properties of the rotor disk and the rotor blades, inter alia for calculating resonance frequencies that are exhibited by the rotor blades in the case of self-excited and forced vibrations. The reduced-order model represents a simplified mathematical model of the rotor disk, wherein a numerical solution is facilitated or simplified as a result of the simplification. By way of example, the simplification is implemented by reduction in the state space and/or the degrees of freedom of the system. According to one configuration of the invention, the reduced-order model is produced on the basis of a model in which the rotor blades are point masses of a damped multi-mass oscillator. An embodiment variant provides for the model described in the publication listed below to be used as a reduced-order model: Yang, M.-T.; Griffin, J. H., 2001. “A Reduced-Order Model of Mistuning Using a Subset of Nominal Modes”. ASME J. of Engineering for Gas Turbines and Power, Vol. 123, October, pp. 893-900.

The first information items in relation to boundary conditions of a rotor disk excitation by way of forced vibrations and the reduced-order model are used to produce a multiplicity of mistuning patterns of the rotor disk. To this end, these information items are provided to a multi-objective optimizer. The multi-objective optimizer produces a plurality of mistuning patterns, wherein there is an optimization, firstly, in respect of the stability of the system in relation to self-excited vibrations and, secondly, in respect of the stability of the system in relation to forced vibrations. These are precisely the two criteria of the multi-objective optimizer. A multi-objective optimization is also referred to as a Pareto optimization. It typically finds use when independent targets exist. This is true in the case of the invention with the criteria of a high stability in relation to self-excited vibrations and a high stability in relation to forced vibrations.

The stability of the system in relation to self-excited or forced vibrations means that excitations of the blades are damped to the greatest possible extent or that the vibration amplitudes at a natural frequency are as low as possible.

During the optimization of the stability of the system in relation to forced vibrations, provision can be made for there to be a simultaneous optimization in relation to at least two resonance frequencies that are excited by forced vibrations.

There is an evaluation for each mistuning pattern determined by the multi-objective optimizer to the effect of numerically carrying out the reduced-order model on a rotor disk that implements the respective mistuning pattern. Here, the properties of this rotor disk are numerically determined in view of self-excited vibrations and in view of forced vibrations. Consequently, the reduced-order model is likewise used to test the mistuning patterns, which are the result of the optimization, in respect of the properties thereof.

Finally, a mistuning pattern is selected, said mistuning pattern then representing the basis for the implementation of a mistuning at an actual rotor disk. An optimal mistuning pattern in which the rotor disk meets criteria defined both in view of self-excited vibrations and in view of forced vibrations to the best possible extent, or at least to the same extent as other mistuning patterns, is selected. By way of example, this is the case if defined criteria in relation to a maximum damping of a vibration produced (such that an excitation decays quickly) and/or in relation to dropping below defined maximum vibration amplitudes (such that only restricted maximum vibration amplitudes occur) are satisfied.

Reference is made to the fact that the result of the method or the undertaken optimization is not necessarily unique. Typically, the possible solutions or mistuning patterns form a solution cloud. Selecting a mistuning pattern corresponds to selecting a solution point from this solution cloud.

According to a configuration of the invention, second information items in relation to random frequency deviations, which can be exhibited by any rotor blade, are additionally provided for the multi-objective optimization. By way of example, the second information items are information items relating to frequency deviations that can be traced back to manufacturing tolerances of the rotor disk during the production thereof and also material inhomogeneities. Such tolerances during the manufacturing process are unavoidable and caused by wear of the tool, for example. In an alternative or complementary manner, the second information items can be information items in relation to frequency deviations that can be traced back to wear and erosion of the rotor disk during operation thereof. Thus, the geometry of the rotor blades changes during the use of the rotor disk in a turbomachine. There are empirical values as to how the natural frequencies in relation to individual vibration modes change after certain periods of use, for example after 6 months or some years depending on the environmental conditions such as sand, dust, sulvor, salt spray, etc. Overall, the second information items provide the inevitable changes/scatter of the natural frequencies that the rotor blades or the rotor disk need to be able to tolerate without having unstable operating states on account of these tolerances.

The information items in relation to frequency deviations that can be traced back to manufacturing tolerances of the rotor disk during the production and or material inhomogeneities thereof can be ascertained by virtue of, for example, information items in relation to frequency deviations being measured on an actual model of the rotor disk. By way of example, this is implemented by virtue of the resonance frequencies being excited by striking the individual rotor blades with an impact hammer and said resonance frequencies being measured for each individual blade. As a result of this, it is possible to easily capture typical deviations in the natural frequencies of the blades caused by the manufacturing process.

Reference is made to the fact that, naturally, the method according to the invention is performed in respect of at least one natural frequency of the rotor blades. However, it is likewise possible, and the case in advantageous configurations of the invention, that an optimization is performed in respect of a plurality of natural frequencies of the rotor blades. Here, provision can be made for a selection of the mistuning pattern to be made under the criterion of the rotor blades being optimized in respect of forced vibrations of the system at two different resonance frequencies. At the same time, there is an optimization in view of stability in relation to self-excited vibrations.

By way of example, natural frequencies are considered to be natural frequencies of the rotor blades in at least one bending mode and/or at least one torsion mode.

The mistuning of a rotor disk according to the invention is particularly advantageous in the case of compressor rotors which only have low structural damping, in particular, if the compressor rotor is of the BLISK type, in which case the rotor disk, the rotor hub and the rotor blades have an integral embodiment (BLISK=“bladed disk”), or if the compressor rotor is of the BLING type, in which case the rotor hub and the rotor blades have an integral embodiment (BLING=“bladed ring”). Accordingly, configurations of the invention provide for the rotor blade to have a BLISK-type or BLING-type embodiment. Rotor disks with a BLISK-type or BLING-type embodiment are more sensitive both in respect of self-excited vibrations and in respect of forced vibrations than conventional rotor blades.

A further configuration of the invention provides for the considered rotor disk to be a fan of a BLISK-type embodiment.

According to a further aspect of the invention, the invention relates to a rotor disk of a turbomachine, the rotor blades of which are provided with a mistuning pattern produced according to a method as claimed in claim 1.

By way of example, the turbomachine in which the rotor disk provided with a mistuning pattern produced according to the invention is a gas turbine, in particular an aero engine, for example a turbofan engine.

### BRIEF DESCRIPTION OF THE DRAWINGS

The invention will be explained in more detail on the basis of exemplary embodiments with reference to the accompanying drawings in which:

FIG. 1 shows a flowchart of a method for producing and selecting a mistuning pattern for a rotor blade;

FIG. 2 shows the compressor map of an axial compressor with separate illustration of instabilities that emerge by a flutter, with three different operating points C1, C2, C3 being illustrated;

FIG. 3 shows the relative frequency deviation in relation to a nominal value depending on the mode ID for two mode families, with measured values on the one hand and values calculated using a reduced-order model (ROM) on the other hand being illustrated;

FIG. 4 shows a first exemplary embodiment of mistuning patterns produced by a method according to FIG. 1 in a diagram which contains the normalized amplitudes of two modes as axes, said modes being excited by forced vibrations, with the produced mistuning patterns forming a point cloud in the diagram;

FIG. 5 shows a second exemplary embodiment of mistuning patterns produced by a method according to FIG. 1 in a diagram which contains the normalized amplitudes of two modes as axes, said modes being excited by forced vibrations, with the produced mistuning patterns forming a point cloud in the diagram;

FIG. 6 shows the normalized amplitude of blades depending on the blade ID for blades with a nominal geometry and for mistuned blades in mode family 1, wherein the amplitudes were ascertained in 3 different ways in each case;

FIG. 7 shows the normalized amplitude of the blade 12 of FIG. 6 depending on the normalized frequency in mode family 1, wherein the normalized amplitude is depicted for the blade with a nominal geometry and for the mistuned blade, and wherein the amplitudes were ascertained in 3 different ways in each case;

FIG. 8 shows the normalized amplitude of blades depending on the blade ID for blades with a nominal geometry and for mistuned blades in mode family 2, wherein the amplitudes were ascertained in 3 different ways in each case;

FIG. 9 shows the normalized amplitude of the blade 12 of FIG. 8 depending on the normalized frequency in mode family 2, wherein the normalized amplitude is depicted for the blade with a nominal geometry and for the mistuned blade, and wherein the amplitudes were ascertained in 3 different ways in each case;

FIG. 10 shows the frequency deviation of a rotor disk provided with a mistuning pattern for mode families 1 and 2 in comparison with the nominal frequency of a non-mistuned rotor disk, wherein the frequency deviation is measured once and calculated once; and

FIG. 11 schematically shows the effects of an optimization using a mistuning pattern produced according to FIG. 1 on the stability of the system in relation to self-excited vibrations using a compressor map.

### DETAILED DESCRIPTION

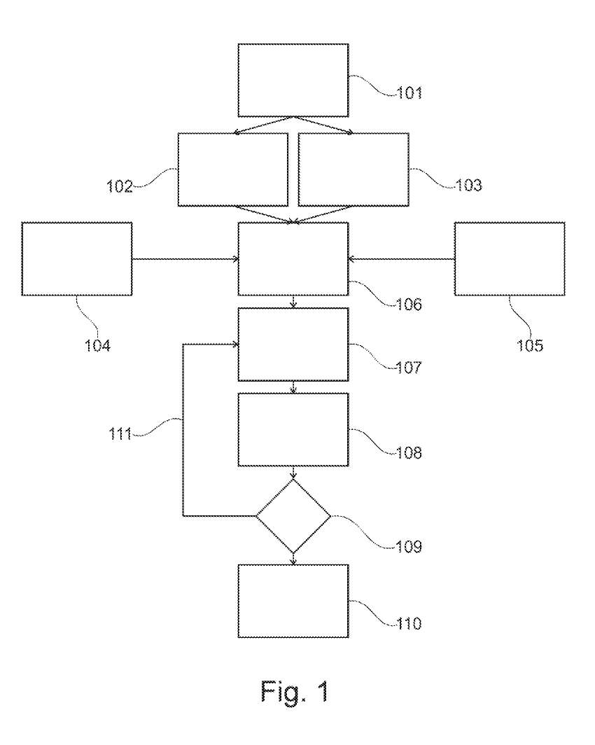

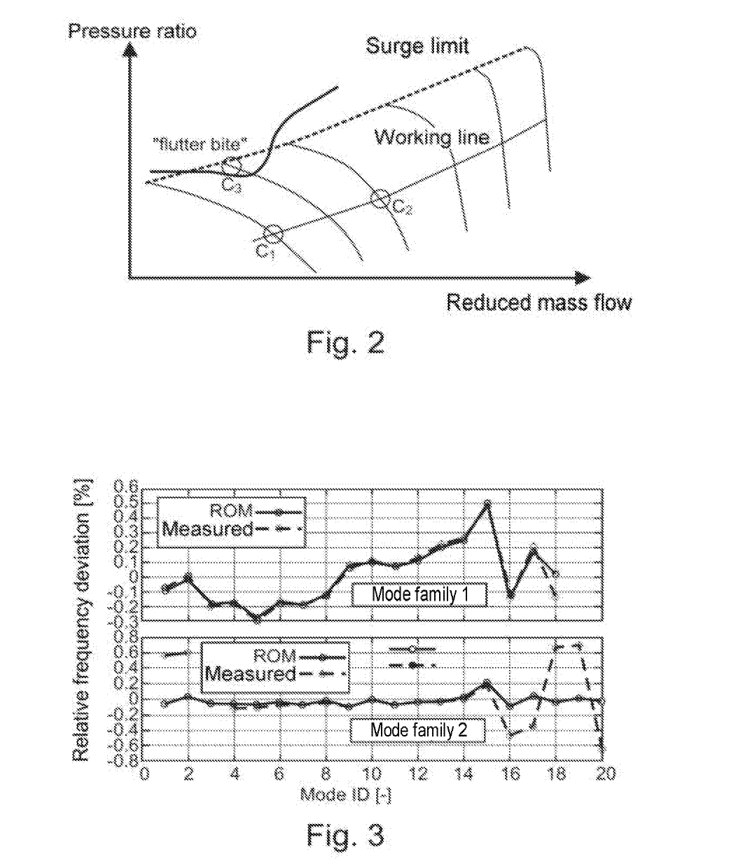

Before an exemplary embodiment of the method according to the invention for producing and selecting a mistuning pattern of a rotor disk of a turbomachine is described on the basis of FIG. 1, the underlying problem is initially clarified on the basis of FIG. 2.

FIG. 2 shows the compressor map of an axial compressor for a fan as a rotor disk considered in an exemplary manner. The compressor map comprises a working line and a surge limit. Two operating points C1, C2 are illustrated, said operating points lying on the working line, with the rotational speed of the rotor disk at operating point C2 being greater than at operating point C1. A resonance frequency of a first vibration mode 1 lies at the operating point C1 and a response frequency of a second vibration mode 2 lies at the operating point C2. Here, the vibration mode 1 has the engine order 2, also denoted “EO”, and the vibration mode 2 has the engine order 4. These two vibration modes 1, 2 are primarily considered within the scope of the following description as they are responsible for the most important resonances of the rotor disk.

Moreover, a relevant operating condition is present at the operating point C3, the rotational speed of which lies between the rotational speeds of the operating points C1 and C2. The operating point C3 lies close to the surge limit. As a result of blade fluttering, the working line is dented at the operating point C3, which is also referred to as a “flutter bite”. This means that the operating point C3 is unstable on account of self-excited vibrations and blade fluttering can occur at this operating point.

Attempts should be made to reduce the size of, or remove, the region referred to as a “flutter bite” in order thereby to enable the engine to be operated up to the surge limit.

Such an optimization can be implemented by introducing mistuning into the rotor blade, for example by virtue of “ABAB . . . ”- or “ABCABC . . . ”-type mistuning patterns being applied to the blades, where A, B and C each specify different natural frequencies of a vibration mode. However, the problem existing here is that although the blade flutter that is traced back to self-excited vibrations can be removed relatively easily, there generally is a target conflict to the effect that forced vibrations increase generally, as a result of the introduction of mistuning, for example the vibrations of the vibration modes 1 and 2 in FIG. 2.

FIG. 1 shows a method for producing and selecting a mistuning pattern, which provides an optimization of a stability of a rotor disk of the system, both in relation to self-excited vibrations and in relation to forced vibrations, and which is particularly suitable for determining and selecting mistuning patterns in which an improvement of the system properties in respect of self-excited vibrations is not disadvantageously accompanied by a deterioration in the system properties in the case of forced vibrations.

In step 101, experimental data in respect of the mistuning of the rotor blades of a rotor disk are ascertained. This comprises two components. Firstly, information items in relation to frequency deviations that can be traced back to manufacturing tolerances and or material inhomogeneities of the rotor disk during the production thereof are captured in step 102. To this end, provision can be made, for example, for the natural frequency in relation to a considered vibration mode and, as a result thereof, the typical frequency deviations between the rotor blades of a considered rotor disk on a produced rotor disk to be ascertained in each case by exciting the individual rotor blades.

Secondly, information items in relation to frequency deviations that can be traced back to wear and erosion of the rotor disk during the use thereof are captured in step 103. Here, it is possible to measure typical wear and erosion when using the rotor disk over a period of 6 months, one year or two years, for example, or measure the frequency changes accompanying this.

The information items captured and provided in step 102 and 103 specify the tolerances for which the system must be transparent within the meaning of no instabilities occurring as a result of self-excited vibrations or as a result of forced vibrations upon occurrence of these tolerances.

The information items are supplied to a multi-objective optimizer 106. The optimizer 106 obtains further information items and boundary conditions from the functional blocks 104, 105. Functional block 104 is a reduced-order model of the rotor disk. The model renders it possible to calculate self-excited and forced vibrations of the rotor disk. As a reduced-order model, this constitutes a simplified mathematical model of the rotor disk, which allows a numerical solution thereof. By way of example, the model described by Yang and Griffin in the following publication is used as a model: Yang, M.-T.; Griffin, J. H., 2001. “A Reduced-Order Model of Mistuning Using a Subset of Nominal Modes”. ASME J. of Engineering for Gas Turbines and Power, Vol. 123, October, pp. 893-900. The calculation is performed on the basis of the relevant equations of motion, where aerodynamic coupling is taken into account by way of an impedance matrix Z and Coriolis forces are taken into account by way of a reduced gyroscopic matrix G.

FIG. 3 elucidates the high degree of correspondence exhibited between measurement values in relation to the relative frequency deviation, calculated or predicted according to this model, and actually measured measurement values. Thus, FIG. 3 shows the relative frequency deviation depending on the mode ID for a first mode family 1 and for a second mode family 2 in the case of an exemplary rotor disk. Here, a mode family comprises all vibration modes of the blades of a rotor disk that correspond to one another (in this case vibration modes 1 and 2). It is possible to recognize that the measured and the calculated values are substantially identical over large areas. This confirms the power of the reduced-order model employed.

Information items in relation to the boundary conditions of a rotor disk excitation by way of forced vibrations are provided in the functional block 105 of FIG. 1. In particular, these boundary conditions are information items relating to wake depressions, which originate from compressor stages or other structures arranged upstream or by the interaction with the potential field of the downstream geometry. To this end, it is possible, for example, to provide information items in respect of how many stages with, in each case, how many blades or vanes are arranged upstream and downstream of the considered rotor disk. The boundary conditions also include information items relating to asymmetries in the engine inlet flow, which arise in the case of crosswinds, for example.

The multi-objective optimizer undertakes an optimization both in view of the stability of the system in relation to self-excited vibrations and in view of the stability of the system in relation to forced vibrations on the basis of the formations and relations provided thereto. Mistuning patterns are the result of such an optimization.

Here, a conventional, commercially available optimizer can be used as an optimizer. The optimizer comprises a random number generator, the numerical values of which form the initial point for the optimizations. In a step 107, the optimizer 106 outputs a plurality of mistuning patterns, with each mistuning pattern specifying how the natural frequency has been modified or mistuned in relation to at least one vibration mode for each rotor blade of the rotor disk.

The result of the two-objective optimization is a plurality of mistuning patterns of the rotor disk, which can be presented as a multidimensional point cloud. The number of dimensions depends on the number of modes in respect of which an optimization had been carried out. According to one configuration, at least two vibration modes that can be traced back to forced vibrations are optimized. By way of example, these are modes 1 and 2 according to the operating points C1 and C2 of FIG. 1.

Each mistuning pattern 107 produced by the optimizer 106 is performed numerically in step 108 using the reduced-order model. Consequently, the reduced-order model once again finds use here. The properties of the rotor disk in view of self-excited vibrations and in view of forced vibrations are calculated and evaluated in step 109 on the basis of the reduced-order model. As already explained above, this can be implemented for one or for more vibration modes. According to an advantageous configuration, at least two vibration modes of forced vibrations are calculated here and there is an optimization of the system in view of these two vibration modes (and also an optimization in respect of self-excited vibrations).

After the calculation and the evaluation in step 109, there is a corresponding calculation for another one of the mistuning patterns produced by the optimizer 106, as indicated by the recursive arrow 111. In the last step 110, a mistuning pattern is selected from the produced and evaluated mistuning patterns. Here, the optimal mistuning pattern is selected. It can be selected in an automated fashion by way of a computer program, or else by a human user.

Here, the optimal mistuning pattern is the pattern in which the properties of the rotor disk meet criteria defined both in view of self-excited vibrations and in view of forced vibrations to the best possible extent. Should the result not be unique, one of the mistuning patterns that meets the defined criteria to the best possible extent is selected. By way of example, the defined criteria are given by requirements in respect of maximum damping and/or dropping below defined maximum vibration amplitudes.

After selecting the optimal mistuning pattern, this is implemented in a corresponding hardware change of a rotor disk. To this end, the individual rotor blades are mistuned during, or after, the production of the rotor disk in terms of their natural frequencies in relation to at least one vibration mode, in each case corresponding to the selected mistuning pattern. This can be carried out in a manner known per se, for example by modifying the geometry of the individual rotor blades.

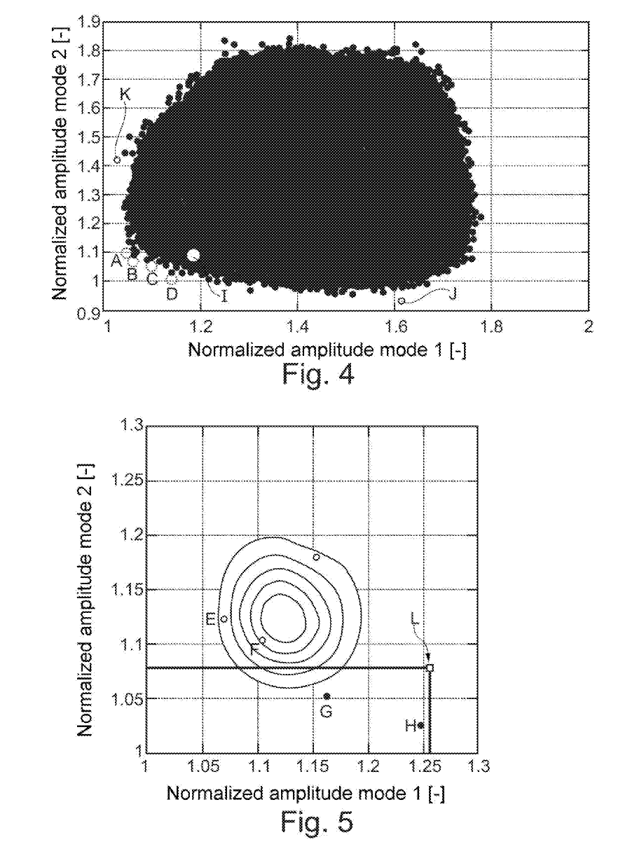

FIGS. 4-11 elucidate the success of the method according to the invention by measuring a mistuned fan. Here, for the purposes of mistuning the rotor blades of the fan, these were coated with one or more color layers. This was carried out in order to realize mistuning in a simple manner within the scope of scientific work. In the case of a rotor blade that is used in a turbomachine, mistuning is brought about in another way, in particular by modifying the geometry of the individual rotor blades, as has already been explained.

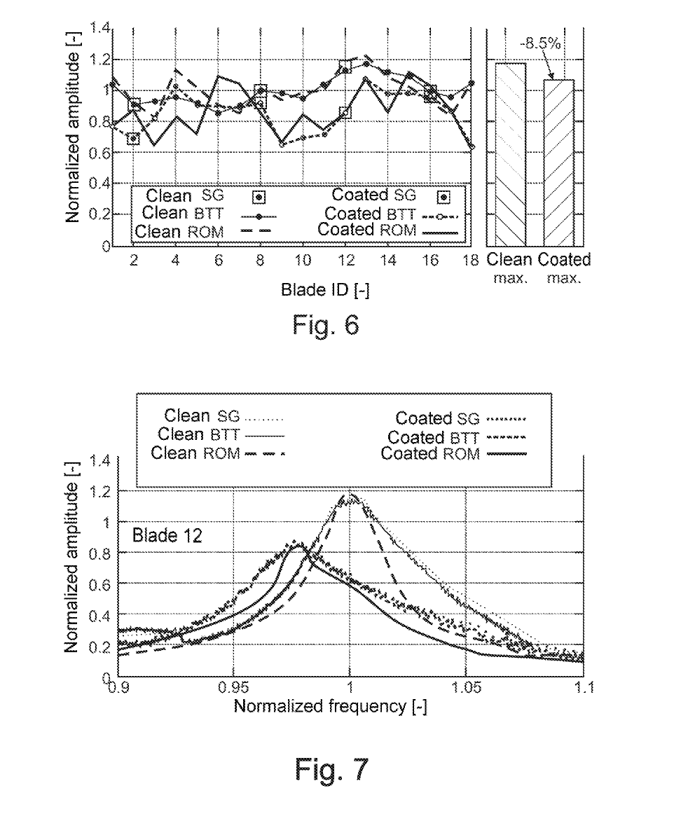

On account of the selected mistuning, FIGS. 6-9 refer in part to “coated” and “clean” rotor blades. Here, the “coated” rotor blades represent, in an exemplary manner, rotor blades that were modified in terms of their natural frequency. The “clean” rotor blades represent, in an exemplary manner, rotor blades that are only provided with the unavoidable mistuning that can be traced back to manufacturing tolerances. The mean natural frequency of the latter rotor blades corresponds at least approximately to the nominal frequency; i.e., the nominal frequency is the frequency that the rotor blades (in each case related to a certain vibration mode) would have in the case of an ideal identical manufacturing process without manufacturing tolerances and without any mistuning. The corresponding amplitude is referred to as nominal amplitude.

FIG. 4 shows a cloud of mistuning patterns, produced in the case of a multi-objective optimization, in a plane in which the normalized amplitude of mode 2 is plotted in relation to the normalized amplitude of mode 1. These modes are primarily excited by forced vibrations. Here, the vibration mode 1 has the “engine order” 2 and the vibration mode 2 has the engine order 4. The point cloud may have further dimensions that relate to further vibration modes, for example even those that are excited in the case of a self-excited vibration.

The normalization is carried out in respect of the nominal amplitude. Attempts should be made to bring the normalized amplitudes of the vibration modes close to the value of 1 or even under the value of 1. The point I in FIG. 4 denotes the vibration amplitudes of an actually produced rotor disk. The point J specifies the global optimum of mode 2. The point K specifies the global optimum of mode 1. However, these global optimums are disadvantageous as they have poor properties in view of the respective other mode.

Points A, B, C and D represent the result of optimizations that were carried out as per a method according to FIG. 1. The mistuning patterns that correspond to the optimizations A, B, C and D have led to the amplitude being reduced both for the vibration mode 1 and for the vibration mode 2 in relation to the produced part (point I), corresponding to an improved damping in view of these two vibration modes.

FIG. 5 shows a further exemplary embodiment of a cloud, which is the result of a multi-objective optimization, in a plane in which the normalized amplitude of mode 2 is plotted in relation to the normalized amplitude of mode 1. The cloud is presented by way of contour lines, wherein the contour lines in the center of the cloud specify a higher empirical probability density for the presence of a mistuning pattern in the respective region.

At point L, FIG. 5 denotes the vibration amplitudes of an actually produced rotor disk. Points E, F, G and H represent the result of optimizations that were carried out as per a method according to FIG. 1. The mistuning patterns that correspond to the optimizations E, F, G and H have led to the amplitude being reduced for the optimizations G and H, both for the vibration mode 1 and for the vibration mode 2, in relation to the produced part (point L). In the case of optimizations E and F, the amplitude for the vibration mode 1 is significantly reduced, while the normalized amplitude for the vibration mode 2 has only been slightly increased.

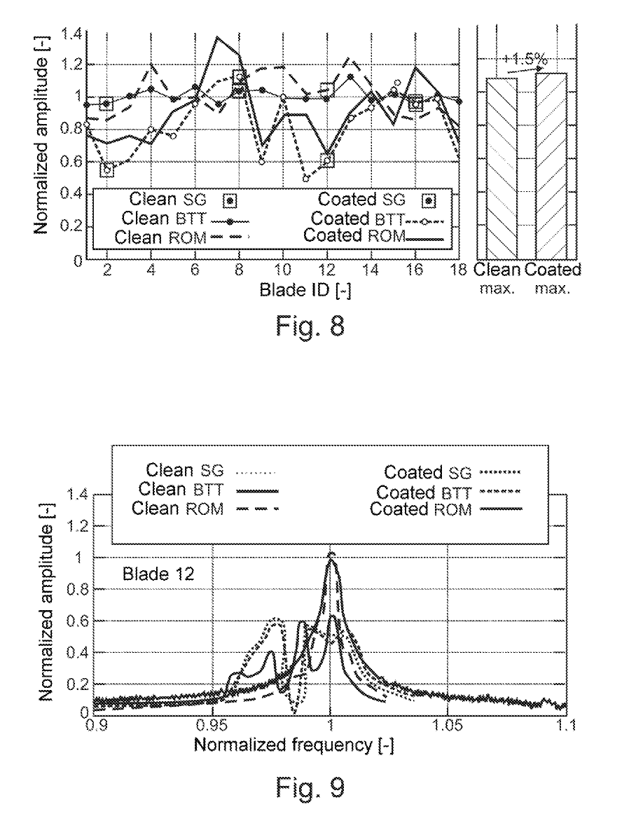

The reduction or only slight increase in the normalized amplitude for the rotor disk provided with a mistuning pattern is additionally illustrated in FIG. 6 for the vibration mode 1 and in FIG. 8 for the vibration mode 2. In the graphs of FIG. 6, which relate to the coated blade, the normalized vibration amplitude lies under the nominal amplitude in almost all blades, wherein there is a normalization in relation to the nominal amplitude. Here, the curve of the nominal amplitude is presented for both the “clean” blade and for the “coated” blade by means of 3 graphs, where SG denotes an actual measurement using a strain gauge, BTT denotes an actual measurement of the blade tip movement and ROM denotes a calculation according to the reduced-order model, with a good correspondence between the calculated and the measured values being conspicuous. In the vibration mode 1 illustrated in FIG. 6, the normalized amplitude is reduced by 8.5% in the mistuned rotor disk. In the vibration mode 2 illustrated in FIG. 8, it is only increased by 1.5%.

Recall that these values are achieved while the fluttering or self-excited vibrations are simultaneously removed entirely by way of the applied mistuning pattern.

FIGS. 7 and 9 show the normalized amplitudes depending on the normalized frequency, where FIG. 6 shows the amplitude for the blade 12 of FIG. 5 and FIG. 9 shows the amplitude for blade 12 of FIG. 8. Here, this is the blade with the greatest vibration amplitude. It is of particular interest. The normalization is brought about in relation to the nominal amplitude or the nominal frequency. Once again, the curve of the nominal amplitude is presented both for the “clean” blade and for the “coated” blade using 3 graphs, where SG denotes an actual measurement using a strain gauge, BTT denotes an actual measurement of the blade tip movement and ROM denotes a calculation according to the reduced-order model. It is possible to recognize in each case that the amplitude of the vibration at the resonant frequency has been reduced by the mistuning. At the same time, the region in which resonances occur has broadened. This corresponds to an advantageous reduction in the vibration energy of the blade with the highest vibration amplitude.

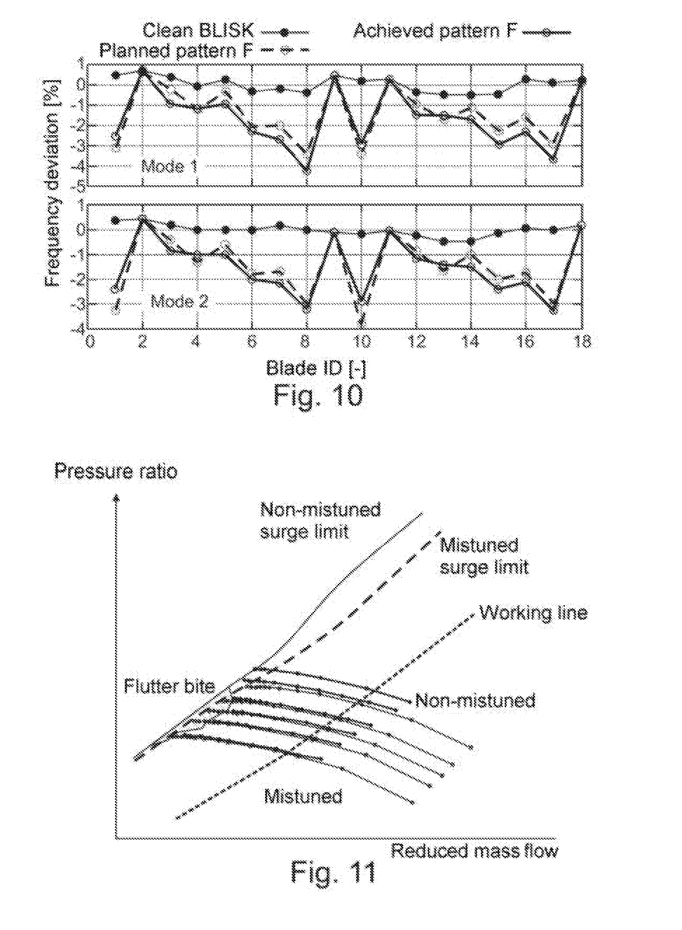

FIG. 10 shows the frequency deviation of a mistuning pattern in relation to the nominal frequency for the blades of the two mode families 1 and 2. Here, the graph “Clean BLISK” specifies the frequency of the original fan blisk without additional intentional mistuning. The minor variations present can be traced back to manufacturing tolerances. The “Planned pattern F” graph specifies for each blade the planned frequency, or the frequency calculated according to the reduced-order model, corresponding to the selected mistuning pattern. The “Achieved pattern F” graph specifies the actual mistuning or frequency deviation achieved in the exemplary implementation for each blade.

FIG. 11 elucidates the success of the method according to the invention, also in view of improving the fluttering. In relation to FIG. 2, the mistuned rotor blade also can realize operating points that lie in the region that represents the fluttering bite in the case of the original fan blisk without intentional mistuning applied. Fluttering or the occurrence of self-excited vibrations is no longer present in the additionally mistuned fan blisk.

In terms of its configuration, the present invention does not restrict itself to the exemplary embodiments described above, which should only be understood as exemplary. By way of example, the exemplary embodiments of FIGS. 2-11 relate to the embodiment of a mistuning pattern for a fan blisk. However, the principles of the present invention apply in a similar manner to any other rotor disks, blisks or blings of a turbomachine. Also, the specifically considered vibration modes should only be considered exemplary. Depending on the form of the rotor blades and the type of excitation, other or additional modes may also be relevant and may be taken into account when creating a mistuning pattern.

It is furthermore pointed out that the features of the individually described exemplary embodiments of the invention can be combined in various combinations with one another. Where areas are defined, they include all the values within these areas and all the sub-areas falling within an area.

What is claimed is:

1. A method for producing and selecting a mistuning pattern of a rotor disk of a turbomachine having a plurality of rotor blades, comprising:
providing first information items in relation to the boundary conditions of a rotor disk excitation by forced vibrations,
providing a reduced-order model of the rotor disk, which allows calculations in relation to self-excited and forced vibrations of the rotor disk, wherein the reduced-order model represents a simplified mathematical model of the rotor disk allowing the numerical solution thereof,
producing a multiplicity of mistuning patterns of the rotor disk, wherein producing the mistuning patterns comprises:
entering the first information items and the reduced-order model into a multi-objective optimizer, and
producing the mistuning patterns by the multi-objective optimizer while optimizing the stability of the system in relation to self-excited vibrations and while simultaneously optimizing the stability of the system in relation to forced vibrations,
for each mistuning pattern produced:
applying the reduced-order model to a rotor disk, which implements the produced mistuning pattern, and
determining the properties of this rotor disk in view of self-excited vibrations and in view of forced vibrations,
selecting one of the mistuning patterns.

2. The method as claimed in claim 1, further comprising that second information items in respect of random frequency deviations, which are exhibited by the rotor blades, are provided and these second information items are likewise supplied to the multi-objective optimizer.

3. The method as claimed in claim 2, wherein the provision of second information items comprises providing information items in relation to frequency deviations that can be traced back to manufacturing tolerances or material inhomogeneities of the rotor disk during the production thereof.

4. The method as claimed in claim 2, wherein the provision of second information items comprises providing information items in relation to frequency deviations that can be traced back to wear and erosion of the rotor disk during the use thereof.

5. The method as claimed in claim 3, wherein the information items relating to frequency deviations are based at least in part on measurements on a model.

6. The method as claimed in claim 1, wherein a mistuning pattern in which the properties of the rotor disk meet criteria defined both in view of self-excited vibrations and in view of forced vibrations to the best possible extent is selected.

7. The method as claimed in claim 6, wherein the defined criteria relate to maximize damping and/or dropping below defined maximum vibration amplitudes.

8. The method as claimed in claim 1, wherein the method is performed in view of at least one natural frequency of the rotor blades.

9. The method as claimed in claim 1, wherein the method is performed in view of a plurality of natural frequencies of the rotor blades.

10. The method as claimed in claim 1, wherein, while optimizing the stability of the system in relation to forced vibrations, there is a simultaneous optimization in view of at least two natural frequencies that are excited by forced vibrations.

11. The method as claimed in claim 1, wherein a mistuning pattern in which the rotor blades are optimized in relation to at least two natural frequencies in view of forced vibrations of the system is selected as mistuning pattern.

12. The method as claimed in claim 1, wherein the reduced-order model of the rotor disk is created on the basis of a model in which the rotor blades are point masses of a damped multi-mass oscillator.

13. The method as claimed in claim 1, wherein the method is performed on a rotor disk of a BLISK-type embodiment.

14. The method as claimed in claim 1, wherein the method is performed on a fan of a BLISK-type embodiment.

15. The method as claimed in claim 1, wherein the method is used to produce a component of an aero engine.

16. A method for producing and selecting a mistuning pattern of a rotor disk of a turbomachine having a plurality of rotor blades, comprising:
providing first information items in relation to the boundary conditions of a rotor disk excitation by forced vibrations,
providing second information items in relation to random frequency deviations, which can be exhibited by any rotor blade,
providing a reduced-order model of the rotor disk, which allows calculations in relation to self-excited and forced vibrations of the rotor disk, wherein the reduced-order model represents a simplified mathematical model of the rotor disk allowing the numerical solution thereof,
producing a multiplicity of mistuning patterns of the rotor disk, wherein producing the mistuning patterns comprises:
entering the first information items, the second information items and the reduced-order model into a multi-objective optimizer, and
producing the mistuning patterns by the multi-objective optimizer while optimizing the stability of the system in relation to self-excited vibrations and while simultaneously optimizing the stability of the system in relation to forced vibrations,
for each mistuning pattern produced:
applying the reduced-order model to a rotor disk, which implements the produced mistuning pattern, and
determining the properties of this rotor disk in view of self-excited vibrations and in view of forced vibrations,
selecting the mistuning pattern or one of the mistuning patterns in which the properties of the rotor disk provided with this mistuning pattern meet criteria defined both in view of self-excited vibrations and in view of forced vibrations to the best possible extent.

17. A rotor disk of a turbomachine, the rotor blades of which are provided with a mistuning pattern produced according to a method as claimed in claim 1.

18. A turbo fan engine having a rotor disk as claimed in claim 17.
